(19) United States
(12) Patent Application Publication
(10) Pub. No.: US 2024/0325884 A1
(43) Pub. Date: Oct. 3, 2024

(54) SYSTEMS AND METHODS FOR MANAGING A MULTI-USER ENVIRONMENT

(71) Applicants: William Chun Sing Anger, Ivry-sur-Seine (FR); Shmuel Silverman, Novato, CA (US)

(72) Inventors: William Chun Sing Anger, Ivry-sur-Seine (FR); Shmuel Silverman, Novato, CA (US)

(21) Appl. No.: 18/617,164

(22) Filed: Mar. 26, 2024

Related U.S. Application Data
(60) Provisional application No. 63/492,304, filed on Mar. 27, 2023.

(51) Int. Cl. A63F 13/352; A63F 13/54; A63F 13/57; G06T 15/00

(52) U.S. Cl. CPC A63F 13/352; A63F 13/54; A63F 13/57; G06T 15/005

(57) ABSTRACT

A system and method for managing a multi-user environment is disclosed. The system is configured to assign at least one server for each client device. The system enables to create at least shard for each user by at least one of the client devices and the server. Each shard encapsulates one or more volumetric spaces and forms at least a portion of the simulation environment. The system is configured to create a finite number of shards for every given area at any given moment. The shards are dynamically selected or created through negotiations between the client device and the server at real time. The shard design (volume and content) is dynamically configured to provide best experience for the client device at the simulation environment.

### CROSS REFERENCE TO RELATED APPLICATION

This application claims priority to U.S. Provisional Patent Application No. 63/492,304 entitled “System and Method for Managing a Multi-user Environment,” filed Mar. 27, 2023, the contents of which is herein incorporated by reference in its entirety.

### TECHNICAL FIELD

The present disclosure generally relates to content management and resource sharing and, more particularly, to systems and methods for managing a multi-user environment.

### BACKGROUND

In the current art, world partitioning is designed to work on a single server, whether local or remote. The rendering is done in one place and could be streamed from a cloud server. However, the problem with this system is the limitation on the number of players allowed in a game at the same time. The system supports a maximum of a few hundred players. Accordingly, there exists a need for new techniques and technology to be integrated into the system to allow for more players.

Further, the existing distribution techniques lack the ability to handle the game graphics and perform limited state management. Additionally, games are hosted on the user's device, for example, PC or laptop. The server can communicate with the user's device and other players in the game environment. The number of connections is relative to the number of players that are slated for updating. This results in a large number of connections and poses a serious challenge. To solve this, centralized servers are provided to communicate with other connected servers. However, the server routinely sends updates, which creates a complex system with a large load and concerns with delay and bandwidth. Therefore, there is a need for an efficient system and method for managing a multi-user environment.

### SUMMARY

One aspect of the present disclosure relates to a system and method for managing a multi-user environment. The system comprises one or more client devices. A client device is associated with a user. The system further comprises one or more servers. At least one server is in communication with at least one client device through a network. The system further comprises one or more databases in communication with the server via the network. The database comprises information related to a plurality of simulation environments.

The server is configured to create at least one shard for each user. Each shard defines at least a volumetric shard (three-dimensional (3D) space and/or an acoustic shard, which is a volumetric space for acoustic dissipation and forms at least a portion of the simulation environment). The clients or users residing in the same shard with the same dimensions and spatial shape may have different objects inside their respective shards. The system is configured to dynamically vary the physical and logical attributes of the shard including the location of the shard at the simulation environment and at least one characteristic of the shard by at least one of the client device and server. The characteristics of the shard include one or more of: dimension, shape, location, content, rendering, and control responsibilities. Further, the location of the shard is determined by the server and communicated to the client device.

The shard can be a dynamic shard. The shard can be a static shard. The shard is a physics simulation and physical attributes-based shard. The volumetric space of the shard is an enclosed volume formed by a plurality of edges. The volumetric space can include a volumetric space in the simulation or as a volumetric part of the simulation environment. The shard enclosure does not limit to a cube but can be any spatial 3D shape. One or more shards could be assigned to a user. The shards assigned to the user could be overlapping, e.g., more than a single shard being assigned to the same volumetric space and coordinates. Shards in the same space may include the same objects or different objects. An acoustic shard is an example of using multiple shards overlapping in a similar 3D space and coordinates. The characteristics of the shard are negotiable between the client device and the server. The characteristic of the shard is varied based on one or more performance factors of at least one of the client devices and servers. Further, each shard comprises an acoustic shard and a volume-based shard. In some cases, the acoustic shard is independent of the volumetric shard. The characteristics of the acoustic shard and the volume-based shard are negotiable between the client device and server.

The server and client device are configured to negotiate and render at the simulation environment. The server and the client device are configured to render within the shard and render outside the shard. The client device is configured to render within the shard, and the server is configured to render at a portion proximal to a border of the shard and a portion outside the shard. Further, the server is configured to stream an environment outside of the shard as video at the walls of the shard. The server provides data to the client device to render the scene outside the shard volumetrically in combination with streaming video or other information. Further, the client device is configured to render sound within the acoustic shard, and the server is configured to render sound at a portion proximal to the border of the acoustic shard and a portion outside the acoustic shard. The server is configured to communicate, to the client, information related to one or more objects to be rendered by the client device. Further, information related to the shard is included in a stream between the client device and the server.

Another aspect of the present disclosure further includes a method for managing a multi-user environment. At one step, one or more client devices, one or more servers, and one or more databases in communication with the server via a network are provided. Each client device is associated with a user. At least one server is in communication with a client device via the network. The database comprises information related to a plurality of simulation environments. At another step, at least one shard for each user is created at the server. A shard can encapsulate one or more volumetric spaces (e.g., as a volumetric space in the simulation or as a volumetric part of the simulation environment) and forms at least a portion of the simulation environment. At yet another step, the physical and logical attributes of the shard including the location of the shard at the simulation environment and at least one characteristic of the shard is varied by at least one of the client device or server. The characteristics of the shard include one or more of: dimension, shape, location, content, rendering and control responsibilities. The shard is a dynamic shard. Further, the shard is a physics simulation and physical attributes-based shard. The characteristics of the shard are negotiable between the client device and the server, and the characteristic of the shard is varied based on one or more performance factors of at least one of the client device or server.

In some embodiments, the shard is a static shard. Since sharding dynamic or static defines the volumetric, acoustic, and physics simulation dimensions in the simulation, there is a possibility to define one or more shards as static but do over sharding. The concept of over sharding means that there can be many shards overlapping but static and defined prior to the simulation execution. The dynamic choice of which plurality of shards is currently active for a specific client is done using the same criteria as for the choice of dynamic sharding described elsewhere herein. The volumetric space of the shard is an enclosed volume formed by a plurality of edges. The volumetric space can include a volumetric space in the simulation or as a volumetric part of the simulation environment. A shard can include an acoustic shard. The acoustic shard comprises a shape and dimension different from the shard having the enclosed volume. The characteristics of the acoustic shard are negotiable between the client device and server.

At yet another step, the client device and the server are configured to negotiate and render at the simulation environment. At yet another step, the client device is configured to render within the shard, and to render sound within the acoustic shard. At yet another step, the server is configured to render at a portion proximal to a border of the shard and a portion outside the shard. At yet another step, the server is further configured to render sound at a portion proximal to a border of the shard and a portion outside the shard. At yet another step, the server is configured to communicate to the client device an information related to one or more objects to be rendered by the client device.

In some aspects, the techniques described herein relate to a system for managing a multi-user environment, including: at least one server in communication with one or more databases and a client device through a network, wherein the at least one server is configured to: receive information corresponding to a plurality of simulation environments from the one or more databases, generate at least one shard forming one or more volumetric spaces of at least a portion of a simulation environment of the plurality of simulation environments, transmit the at least one shard to the client device, dynamically vary one or both of a physical attribute or a logical attribute of the at least one shard, and transmit the dynamically varied at least one shard to the client device.

In some aspects, the techniques described herein relate to a system, wherein the physical attribute is a location of the at least one shard. In some aspects, the techniques described herein relate to a system, wherein the logical attribute is at least one characteristic of the at least one shard. In some aspects, the techniques described herein relate to a system, wherein the at least one characteristic of the at least one shard is one or more of: a dimension, a shape, a location, a content, a rendering, or a control responsibility.

In some aspects, the techniques described herein relate to a system, wherein the at least one shard is a dynamic shard. In some aspects, the techniques described herein relate to a system, wherein the at least one shard is a static shard. In some aspects, the techniques described herein relate to a system, wherein the at least one shard is at least one of an acoustic shard, a volumetric shard, a physical simulation shard, or any combination thereof. In some aspects, the techniques described herein relate to a system, wherein the at least one shard is a physics simulation and a physical attributes-based shard.

In some aspects, the techniques described herein relate to a system, wherein the at least one server is further configured to negotiate the at least one characteristic of the at least one shard with the client device. In some aspects, the techniques described herein relate to a system, wherein the at least one server is further configured to vary the at least one characteristic of the at least one shard based on one or more performance factors of at least one of the client device communicatively coupled to the at least one server.

In some aspects, the techniques described herein relate to a system, wherein the at least one shard includes a volumetric space that defines an enclosed volume formed by a plurality of edges. In some aspects, the techniques described herein relate to a system, wherein: the at least one server is further configured to generate a second shard, the second shard includes an acoustic shard, the acoustic shard includes a shape and dimension different from the at least one shard, and at least one characteristic of the acoustic shard is negotiable between the client device and the at least one server. In some aspects, the techniques described herein relate to a system, wherein the at least one server is a plurality of servers configured to negotiate and render content at the simulation environment of the plurality of simulation environments. In some aspects, the techniques described herein relate to a system, wherein the at least one server is configured to cause the client device to render content: within the at least one shard; outside the at least one shard. In some aspects, the techniques described herein relate to a system, wherein the at least one server is configured to cause the client device to render content: within the at least one shard; at a portion proximal to a border of the at least one shard; and at a second portion outside the shard. In some aspects, the techniques described herein relate to a system, wherein the at least one server is configured to: stream the simulation environment outside of the at least one shard as video at one or more walls of the at least one shard.

In some aspects, the techniques described herein relate to a system, wherein the at least one server is configured to: cause the client device to render sound within the acoustic shard, and render the sound at a portion proximal to a border of the at least one shard and at a second portion outside the at least one shard. In some aspects, the techniques described herein relate to a system, wherein the at least one server is further configured to: determine the location of the at least one shard, and transmit the location to the client device. In some aspects, the techniques described herein relate to a system, wherein the at least one server is further configured to: transmit, to the client device, an information corresponding to one or more objects to be rendered by the client device.

In some aspects, the techniques described herein relate to a system, wherein the information related to the at least one shard is included in a stream between the client device and the at least one server. In some aspects, the techniques described herein relate to a system, further including the client device and the one or more databases. In some aspects, the techniques described herein relate to a method for managing a multi-user environment, the method performed by at least one server and including: receiving information corresponding to a plurality of simulation environments from one or more databases; generating at least one shard forming one or more volumetric spaces of at least a portion of a simulation environment of the plurality of simulation environments; transmitting the at least one shard to a client device; dynamically varying one or both of a physical attribute or a logical attribute of the at least one shard; and transmitting the dynamically varied at least one shard to the client device.

In some aspects, the techniques described herein relate to a method, wherein the physical attribute is a location of the at least one shard and wherein the logical attribute is at least one characteristic of the at least one shard. In some aspects, the techniques described herein relate to a method, wherein the varying of one or both of the physical attribute or the logical attribute of the at least one shard is based at least in part on one or more performance factors of the client device or the at least one server. In some aspects, the techniques described herein relate to a method, wherein the at least one characteristic of the at least one shard is one or more of: a dimension, a shape, a location, a content, a rendering, or a control responsibility.

In some aspects, the techniques described herein relate to a method, wherein the at least one shard is a dynamic shard. In some aspects, the techniques described herein relate to a method, wherein the at least one shard is a static shard. In some aspects, the techniques described herein relate to a method, wherein the at least one shard is at least one of: an acoustic shard, a volumetric shard, a physical simulation shard, or any combination thereof. In some aspects, the techniques described herein relate to a method, wherein the at least one shard is a physics simulation and a physical attributes-based shard.

In some aspects, the techniques described herein relate to a method, wherein the at least one server is a plurality of servers and the method further includes: negotiating the at least one characteristic of the at least one shard between the client device and the plurality of servers. In some aspects, the techniques described herein relate to a method, further including varying the at least one characteristic of the at least one shard based on one or more performance factors of at least one of the client device or the at least one server. In some aspects, the techniques described herein relate to a method, wherein the one or more volumetric spaces of the at least one shard is an enclosed volume formed by a plurality of edges. In some aspects, the techniques described herein relate to a method, further including generate a second shard, wherein: the second shard includes an acoustic shard, the acoustic shard includes a shape and dimension different from the at least one shard, and at least one characteristic of the acoustic shard is negotiable between the client device and the at least one server.

In some aspects, the techniques described herein relate to a method, further including one or more of: negotiating and rendering at the simulation environment by the one or more servers; causing the negotiating and rendering at the simulation environment by the client device; causing the rendering within the at least one shard and within the acoustic shard by the client device; rendering outside the at least one shard, and at a portion proximal to a border of the at least one shard and at a portion outside the at least one shard; rendering outside an acoustic volume-based shard, and at a portion proximal to a border of the at least one shard and at a portion outside the at least one shard; and transmitting to the client device an information corresponding to one or more objects to be rendered by the client device.

This summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following sections.

### BRIEF DESCRIPTION OF THE DRAWINGS

FIG. 1 exemplarily illustrates an environment of a system for managing a multi-user environment.

FIG. 2 is a schematic of an environment of the system for managing the multi-user environment of FIG. 1, illustrated in a detailed aspect.

FIG. 3 exemplarily illustrates a representation of a plurality of shards for a plurality of users.

FIG. 4 exemplarily illustrates a process for establishing a session between the server and the client device.

FIG. 5 exemplarily illustrates a process of the server providing support to the client device in rendering one or more layers.

FIG. 6 is a schematic diagram showing one or more layers rendered by the client device.

FIG. 7 exemplarily illustrates a process of dynamically changing the dimension of the shard.

FIG. 8 exemplarily illustrates a process for dynamic control and sound rendering between the client device and server.

### DETAILED DESCRIPTION

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

A world partition system represented in massively multiplayer online games (MMOGs) generally involves fragmenting of the game world (e.g., game environment) into shards. The shards are managed by their assigned and dedicated one or more servers. The system may use distribution techniques, for example, sharding, zoning, cloning, or instancing, to partition the game world and control the partitions with different servers. The system enables the use of an infinite world size while the local engine streams and manages resources related to the partitions being played in or visited by the game user(s). Further, different levels of detail could be triggered by possibly the user's location or actions or a combination thereof within the partition by the system. Further, the system enables the use of level streaming to load and unload map files into memory and toggle their visibility during play.

Advantageously, systems and methods described herein may render a game environment within a shard and project the game environment outside the shard. For example, the systems and methods described herein may project the game environment as video on the walls of the shard, thereby reducing an amount of rendering utilized by the environment. Further, in some embodiments of a game environment, rendering the entire simulation environment may not be required. The systems and methods described herein enable a client device to render at a volume of the shard, and one or more characteristics of the shard based at least in part on performance factors of the client device. Thus, the system may not be limited by the number of users. Further, the effectiveness of the system increases with increase in the number of client devices (e.g., users).

The proposed solutions described herein solve technical problems for virtual reality (VR) and/or augmented reality (AR) environments by assessing different capabilities (e.g., between different VR devices, controllers, consoles, or the like) and modifying graphical content and/or audio content to allow several client devices with varied different capabilities to play in the same environment. Such content may be provided based on client-available resolutions, sizes, shard characteristics, and/or other attributes. Thus, the systems and methods described herein dynamically vary characteristics of the game environment based on the configurations of a particular client device (e.g., computers, controllers, memory resources, Internet speed, battery charge, availability, and/or network configuration) while varying the same or other characteristics of other client devices based on the respective other client device configurations.

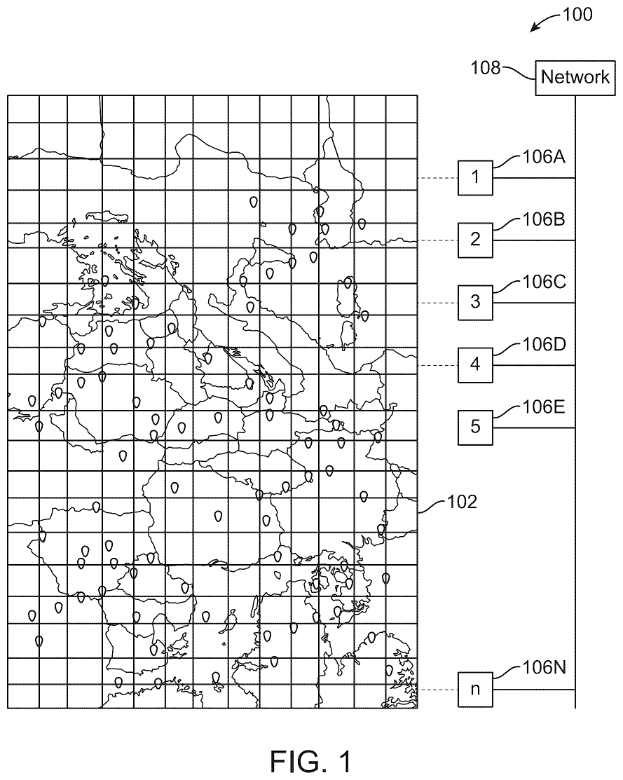

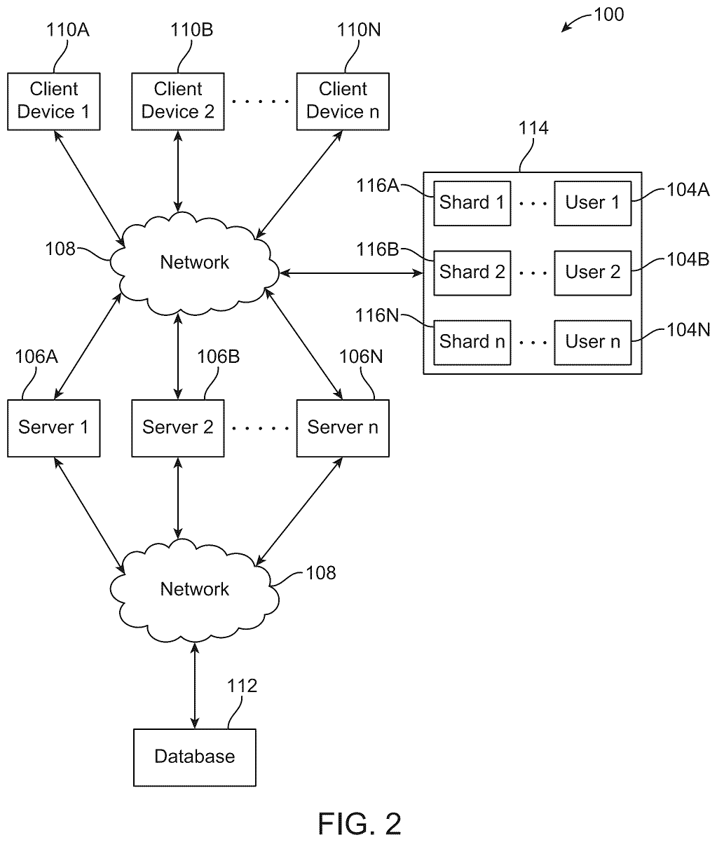

FIGS. 1-2 show schematics of system for managing a multi-user environment. FIG. 1 exemplarily illustrates a simplified environment of a system 100 for managing a multi-user environment 102. The multi-user environment 102 includes a plurality of users (104A, 104B, 104N) (hereinafter referred as user 104, and shown in FIG. 2). The system comprises a plurality of servers (106A, 106B, 106N) (hereinafter referred as 106) connected to a network 108. The system includes a plurality of client devices (110A, 110B, 110N) (hereinafter referred as client device 110, and shown in FIG. 2). A client device 110 is associated with the respective user 104.

The system is configured to assign at least one server 106 for each client device 110. The system enables creation of one or more shards (116A, 116B, 116N) (hereinafter referred as 116N, and shown in FIG. 2) for a user 104 by at least one of the client device 110 or the server 106. A shard 116 encapsulates one or more volumetric spaces (e.g., as a volumetric space in the simulation or as a volumetric part of the simulation environment) and forms at least a portion of the simulation environment 114.

The system varies at least one characteristic of the shard 116 by at least one of client device 110 or server 106. The characteristics of the shard 116 include, but are not limited to, dimension and shape. As shown in FIG. 2, the shards 116 are static and form a static simulation environment 114. The system is configured to dynamically vary the physical and logical attributes of the shard 116 including the location of the shard 116 at the simulation environment 114 and at least one characteristic of the shard 116 by at least one of the client device 110 or server 106. The characteristics of the shard 116 include dimension, shape, location, content, rendering and control responsibilities. In some embodiments, the shard 116 is a dynamic shard. In some embodiments, the shard 116 is a static shard and uses over sharding. In the concept of over sharding, the system could have many static shards 116 that include overlaps. The static and overlapping shards 116 are defined prior to the simulation execution. The dynamic choice of which plurality of shards 116 is currently active for a specific client is done using the same criteria as for the choice of dynamic sharding as described elsewhere herein.

The shards 116 are dynamic and form a dynamic simulation environment 114 in real-time. The system is configured to dynamically change the characteristics of the shard 116 in real time based on the performance factors of the client device 110. The system is further configured to dynamically change the characteristics of the shard 116 in real time based on the performance factors of the client device 110 and server 106. Example performance factors may include, but are not limited to, network performance, local system processing requirements outside of a simulation environment, a phone call or other received (or in progress task), a change in local device resolution, a rise in device temperature above a threshold that may impact processing speed, network traffic, etc.

In general, there is a large but finite number of shards 116 for a given area at any given moment. The shards 116 are dynamically selected or created through negotiations between the client device 110 and the server 106. The shard design (volume and content) is dynamically configured to enable an improved game experience for the client device 110. The shard dynamic configuration is called sharding. Network performance will influence sharding.

FIG. 2 is the environment 100 of the system and method for managing the multi-user environment 102 of FIG. 1 illustrated in detailed aspect. The system comprises one or more servers 106 and one or more client devices 110. A client device 110 is associated with a user 104. At least one server 106 is in communication with each client device 110 via network 108. The system further comprises one or more databases 112 in communication with server 106 via network 108. The database 112 comprises information related to the user 104 and information related to a plurality of simulation environments 114. The database 112 comprises a dataset. The dataset structures are designed for efficient retrieval according to the dynamic game shard structure. Due to the dynamics and fluidity in the sharding process, the structure of the database 112 is designed to allow the dynamic creation of datasets that reflect the variety and uniqueness of views experienced by the user 104 in this game/simulation. The database 112 is designed to enable assets to be communicated to the client device 110. The assets can be atomically connected and broken into dictionaries of assets. The shard dynamics generates the map between a given shard 116 and assets in the database 112. This map is used to dynamically load assets into the client device 110 in real-time.

The database 112 further comprises information to create the simulation environment 114, for example, atmospheric data, terrain data, weather data, temperature data, location data, and other data used to define and/or describe the plurality of simulation environments 114. Additionally, data defining various conditions that govern the operation of the simulation environment 114 may include, for example, laws of physics, time, spatial relationships, and other data that may be used to define and/or create various conditions that govern the operation of the simulation environment 114.

The entity, object, condition, characteristic, behavior, or other feature of the simulation environment 114 will be generically referred to herein, unless the context indicates otherwise, as an object (e.g., digital object, virtual object, rendered physical object, etc.). Objects may be any type of animate or inanimate object, including but not limited to, buildings, plants, vehicles, people, animals, creatures, machines, data, video, text, pictures, and other users 104. Objects may also be defined in the simulation environment 114 for storing information about items, behaviors, or conditions actually present in the physical world. The data that describes or defines the entity, object or item, or that stores its current state, is generally referred to herein as object data.

Each server 106 comprises one or more processors for executing program instructions. The server 106 also includes memory for storing the program instructions and data that is used and/or generated by processes being carried out by the server 106 under direction of the program instructions. The client device 110 is generally a computer or computing device including functionality for communicating (e.g., remotely) over network 108. The client device 110 comprises one or more processors for executing program instructions. The client device 110 also includes memory for storing the program instructions and data that is used and/or generated by processes being carried out by the client device 110 under the direction of the program instructions.

The client device 110 may be a desktop computer, laptop computer, personal digital assistant (PDA), smart phone, or mobile gaming device. The client device 110 may execute one or more client applications, such as a web browser to access and view content over a computer network. The client device 110 is associated with user 104.

The network 108 communicates data between the client devices 110, servers 106 and databases 112. The network 108 represents the communication pathways between the server 106, client device 110, and any other entities. The network 108 is the Internet and uses standard communications technologies and/or protocols. Thus, the network 108 can include links using technologies such as Ethernet, worldwide interoperability for microwave access (WiMAX), 3G, long term evolution (LTE), digital subscriber line (DSL), asynchronous transfer mode (ATM), InfiniBand, PCI Express Advanced Switching, etc. Similarly, the networking protocols used on the network 108 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 108 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The system may also use custom and/or dedicated data communications technologies instead of, or in addition to, the ones described above.

The client device 110 and the server 106 further comprise one or more processors, including graphic processors for rendering and generating graphics, images, video, audio, and/or multimedia files. The server 106 is configured to create at least one shard 116 for many users 104. Each shard 116 can define one or more shards, e.g., volumetric spaces (as a volumetric space in the simulation or as a volumetric part of the simulation environment), and forms at least a portion of the simulation environment 114. The number of shards per client on the server and the number of shards on the client are not limited.

The system is configured to dynamically vary the location of the shard 116 at the simulation environment 114 and at least one characteristic of the shard 116 by at least one of the client device 110 or server 106. The location of shard 116 is determined by the server 106 and communicated to the client device 110. The characteristics of the shard 116 include dimension and shape. In some embodiments, the shard 116 is a dynamic shard. In some embodiments, the shard 116 is a static shard and uses over sharding. In the concept of over sharding, the system could have many static shards 116 that overlap. The static overlapping shards 116 are defined prior to the simulation execution. The dynamic choice of which plurality of shards 116 is currently active for a specific user/client is done using the same criteria as for the choice of dynamic sharding described elsewhere herein. In some embodiments, the shard 116 is a physics simulation and physical attributes-based shard in which a local client machine may be provided instructions for depicting such simulations on physical attributes associated with a shard. In particular, one or more servers 106 may determine the capabilities of a client device in order to determine whether the server 106 will generate and send the simulation or provide instructions and data for the client device to generate the simulation locally. Different users (i.e., client devices) may have different capabilities and accordingly, the server 106 can determine on an individual client device basis whether to allow a respective client device to generate the simulations. In a non-limiting example, if the server 106 determines that client device 110 has a large amount of computational capabilities, the server 106 may send a suggestion of what should be depicted or acoustically generated with respect to a particular shard to be cohesive with an environment, game session, other shards, etc. If the server 106 determines instead that client device 110 does not have computational capabilities to perform a particular physics simulation for a shard, then the server 106 can generate the simulation and provide (e.g., stream, send directly, etc.) the simulation to the client device 110. In either example, the client device may modify a size of a shard to accommodate complexities that may occur because of an increase in communication between the server 106 and the client device 110.

Other example physical occurrences/simulations that may include changing physical attributes of a shard may include a simulation of a building collapsing. There are many ways to simulate the collapse of a building that may be illustrated with simple or complex graphics or anything in between simple and complex graphics. The server 106 may determine client device capabilities before generating and sending instructions for how to depict the collapse of the building. Other graphic simulations are of course possible. In general, each physical attribute that is slated to be changed for a shard may depend upon different client device locations, points of view, machine capabilities, etc.

In some embodiments, the shard 116 may be represented by a physics engine software component associated with one or more servers 106 (or client device 110 if capable) that may model dynamic behavior with respect to one or more bodies (e.g., shards/data representing physical elements in streaming data). The physics engine may perform a physics simulation to model shard 116 changes and/or related movements by determining which bodies will be simulated and how each simulation will be configured and/or how each body will move with respect to inertia, force, mass, acceleration, action, and/or reactions that may occur in the stream. In some embodiments, the server may request to utilize additional performance speed, bandwidth, or other metric from the client in order to deliver a quality simulation with respect to physics characteristics (e.g., simulated content). Accordingly, particular physics simulations may partially impact a number of client devices which can represent a different view with various different physics characteristics based on such views. For example, a simulation that depicts lava pouring from an underwater facility may be depicted with different physics characteristic than a simulation that depicts lava being poured on land. In particular, since the volumetric space (e.g., as a volumetric space in the simulation or as a volumetric part of the simulation environment) of the shard 116 is an enclosed volume formed by a plurality of edges, the edges may vary depending on the surrounding environment (e.g., underwater vs. land) and/or client device capabilities. Accordingly, the systems described herein may modify the physics characteristics to account for such differences in the surrounding environment as well as the capabilities of each particular client device

The characteristics of the shard 116 are negotiable between the client device 110 and the server 106. For example, each change that is slated to occur in a shard and/or in an environment surrounding the shard may be determined according to client device capabilities. As such, the server 106 may communicate with the client device 110 any number of times to determine device capabilities and may then arrive upon suggested changes to characteristics/aspects of the shard for the specific client device 110. The server 106 may perform different negotiations to arrive upon a suggested changes to characteristics/aspects of the same shard for another client device. In this way, the characteristic of the shard 116 may be varied based on one or more performance factors of at least one of client device 110 and/or server 106. Further, a shard can comprise an acoustic shard and/or a volume-based/volumetric shard. The acoustic shard is independent of the volumetric shard. The characteristics of the acoustic shard and the volume-based shard are negotiable between the client device 110 and server 106. In general, an acoustic shard may be larger than a volumetric shard since acoustic changes generally use less network bandwidth and device resources.

The server 106 and client device 110 are configured to negotiate and render graphics, images, video, audio, and/or multimedia files at the simulation environment 114. The server 106 and the client device 110 are configured to render such content within the shard 116 and render such content outside the shard 116.

The client device 110 is configured to render within the shard 116, and the server 106 is configured to render at a portion proximal to a border of the shard 116 and at a portion outside the shard 116. Further, the server 106 is configured to stream an environment outside of the shard 116 as video at the walls of the shard 116.

Further, the client device 110 is configured to render sound within the acoustic shard, and the server 106 is configured to render sound at a portion proximal to a border of the shard and at a portion outside the shard. The server 106 is configured to communicate to the client an information related to one or more objects to be rendered by the client device 110. Further, an information related to the shard 116 is included in a stream between the client device 110 and the server 106.

FIG. 2 may represent a system 100 for managing a multi-user environment. The system 100 may include any number of client devices 110 and/or server devices 106 for communicating over a network 108 with one another and/or database 112. In one non-limiting example, the system 100 includes at least one server 106 in communication with one or more databases 112 and a client device 110 through a network 108. In operation, the server 106 may receive information corresponding to a plurality of simulation environments from the one or more databases 108. For example, the server 106 may receive environment data or object data pertaining to a gaming environment, game session information pertaining to one or more gaming sessions, graphics or acoustic data pertaining to generating one or more simulations in a gaming environment, or the like.

The server 106 may generate at least one shard 116 forming one or more volumetric spaces of at least a portion of a simulation environment of the plurality of simulation environments. For example, the server 106 may generate graphical data and/or acoustical data for at least one shard 116 in a simulation environment associated with a gaming environment, for example. The server 106 may transmit the shard 116 to the client device 110. The server 106 may then dynamically vary one or both of a physical attribute or a logical attribute of the shard 116. For example, a physical attribute such as an animation may be modified for the shard and the modification may be performed on the server 106. The modification may include one or more instructions for modifying the shard 116. Such instructions may be transmitted to the client device 110. In some embodiments, the dynamically varied shard may be transmitted to the client device 110 instead of instructions, for example, if the server 106 determines that the client device 110 cannot perform the instructions to modify the shard at the client device.

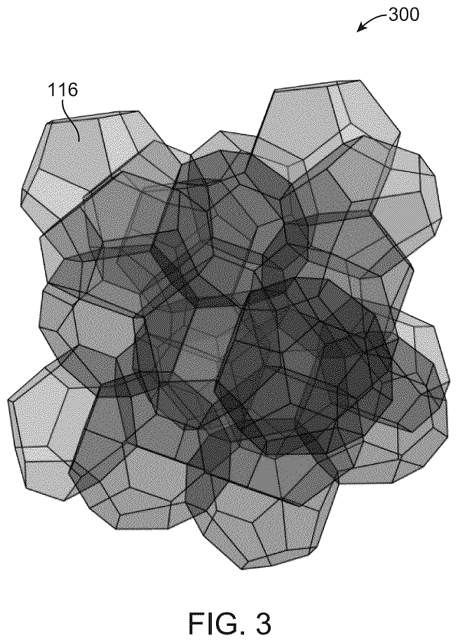

FIG. 3 exemplarily illustrates a representation 300 of a plurality of shards 116 for a plurality of users 104. The shard 116 defines an enclosed geometric spatial volume. The shard 116 further defines an acoustic volume. The dimension of the shard 116 is computed algorithmically based on the flow of activity of the client device 110 in the simulation environment 114. In some embodiments, the dimension of the shard 116 is controlled by the server 106. In some embodiments, the dimension of the shard 116 is controlled by the client device 110 and the server 106. The dimension of the shard 116 could be varied based on the activity of the client device 110 in the simulation environment 114. The shard 116 has a shape including, but not limited to a closed box. The spatial volume and acoustic volume coexist in the closed box of the shard 116. The dimension of the shard 116 is based on factors, including, but not limited to, capabilities of the client device 110, minimal network bandwidth, delay and jitter, game complexities, and physics and realism level of the client device 110. Thus, a client device 110 can have a shard 116 of different dimension(s).

For example, the client device 110A includes the shard 116A having a first dimension, and the client device 110B includes the shard 116B having a second dimension. The first dimension is larger than the second dimension because the performance factors of the client device 110A is better compared to the performance factors of the client device 110B. The shard 116B may have the second dimension, which may be a subset of the first dimension of the shard 116A. In some embodiments, the shard 116 is a spatial-volume based shard. In some embodiments, the shard 116 is an acoustic-based volume. In some embodiments, the shard 116 is a simulated physics-based shard. In some embodiments, the shard 116 is a physics simulation and physical attributes-based shard. The server 106 is configured to dynamically change the shards 116 based on the parameters of the simulation environment 114. If the simulation environment 114 is a gaming environment, the server 106 is configured to dynamically change the characteristics and types of shards 116 based on factors, including, but not limited to, player movement, other players nearby, and physics and effects for the gameplay.

The server 106 is configured to position the user 104, or an object representing the user 104 at a center of the shard 116. Simultaneously, the server 106 and/or the client device 110 could statically, or dynamically devise the characteristics of the shard 116 and/or location of the shard in the simulation environment 114, while maintaining the position of the user 104 at the center of the shard 116.

The server 106 is configured to over-partition the simulation environment 114 so that the user 104 is located at the center, or proximal to the center of the shard 116. The server 106 is configured to join one or more shards 116 to the simulation environment 114, or unjoin one or more shards 116 from the simulation environment 114 to create a correct optimized volume of the simulation environment 114 to enable enhanced quality and performance for the activity performed in the simulation environment 114. In an example, the activity could be a gameplay activity and the simulation environment 114 could be a virtual game environment.

The server 106 is configured to dynamically shard the simulation environment 114 based on one or more parameters of the activity performed at the simulation environment 114 while centering the user 104 within their respective shards 116 at any given moment. The client device 110 is further configured to negotiate the shard-supported features based on local resource availability. These negotiations could be static at the initiation of the session or dynamic throughout the session at the simulation environment 114.

The server 106 is configured with a machine learning module to generate mainframes. Further, the client device 110 is configured with a machine learning module to stitch the frames received from the server 106. This allows for a high frame rate independent of the client-to-server connection bandwidth.

In some embodiments, the client device 110 is a virtual reality (VR) system and the simulation environment 114 is a real-word map. The server 106 is configured to position the user 104 inside the shard 116 and augment the experience of the user 104 in the virtual reality system. In some embodiments, the client device 110 is an augmented reality (AR) system. The size of the shard 116 is dynamically changed based on the performance factors of the client device 110 and/or the real-time parameters indicated by or received by a user 104. The performance factor of the client device 110 impacts the zoning decision and the dimension of the shard 116. The user 104, respective of the VR system and AR system, could be present inside their respective shard 116. Further, the user 104 associated with the VR system could use the client device 110 outside the zone they are digitally present in, e.g., on another global network. Further, object mobility is considered and managed inter-shard and intra-shards and maintained by the network 108. The mobility issues can be addressed based on IPv6.

In some embodiments, the client device 110 is configured to render within the shard 116 and the server 106 is configured to render outside the shard 116. In some embodiments, the client device 110 and the server 106 is configured to render within the shard 116. In some embodiments, the client device 110 and the server 106 is configured to render outside the shard 116. The at least one of the client device 110 or server 106 is configured to render at an area proximal to the border of the shard 116. The server 106 includes a velocity-based algorithm to decide party responsible to render objects on the border to eliminate negative video side effects. For example, in the case of gaming environment, other player's information may not be maintained locally and could be managed in the server 106, assuming the other players are outside of one's shard 116. The shard is at least one of an acoustic shard, volumetric shard, or physical simulation shard.

Referring to FIG. 3, the shard 116 is an enclosed space formed by a plurality of edges. The server 106 is further configured to stream 5× video channels to the user 104, or the player (in case of gaming environment) continuously from server 106. The channels are streamed on the walls of the shard 116. These video streams are subject to normal video compression. Without limitation, the sharding principle depends on a cooperation between the client device 110 and the server 106 or the client device 110 itself using ML or other algorithms with some hints from the server 106. For example, the shard 116 could be procedurally generated on the client device 110 in some cases. Without limitation, outdoors and indoors, or streets or bordered environments will be impacted by lights and other energy sources inside the shard 116 and may receive support from the client device 110 for rendering. In principle, a game is composed of multiple types of objects. Some objects are controlled by their own AI, many are static or can be interacted with by the players (human or AI), and some objects are procedurally generated. As part of the present disclosure, the system is configured to run the game or simulation without human plays via a Machine Learning (ML) system that allows it to predict object behavior (likely behavior) within several subsequent frames. The ML is locally integrated with the video streams.

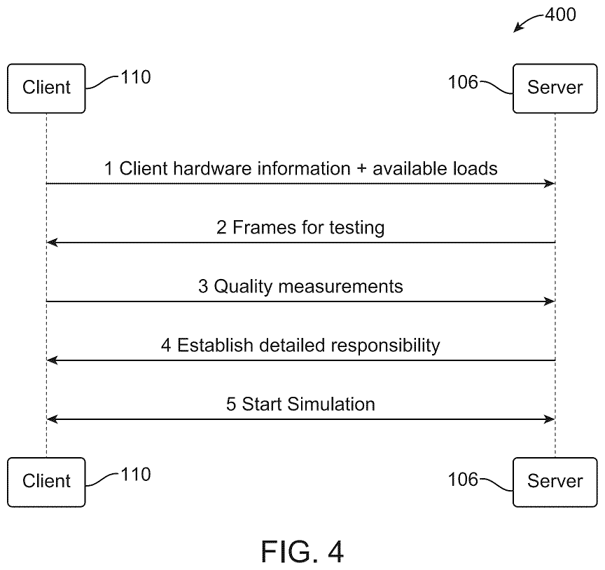

FIG. 4 exemplarily illustrates a process 400 establishing a session between server 106 and the client device 110. Referring to FIG. 4, the server 106 is configured to receive information related to hardware and load of the client device 110. The server 106 is further configured to send frames for testing to the client device 110, and receive performance and quality measurements from the client device 110. The server 106 may authorize to establish a session between the client device 110 and the server 106. The server 106 authorizes a session when the client device 110 negotiates a reasonable performance. On authorization, the session is established between the client device 110 and server 106 for further simulation.

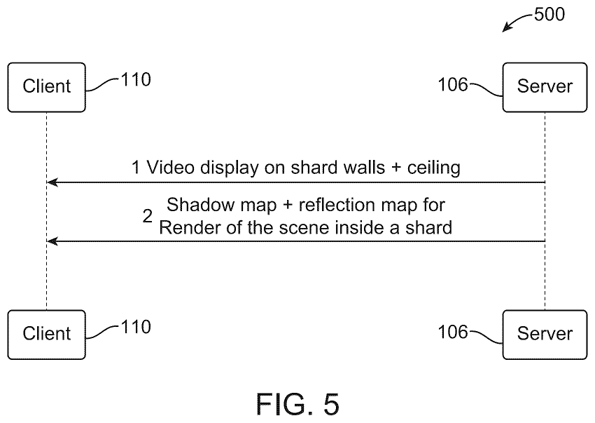

FIG. 5 exemplarily illustrates a process 500 of the server 106 providing support to the client device 110 in rendering of one or more layers. Based on the capability of the client device 110, the server 106 is configured to provide support in rendering the objects in the simulation environment 114. The server 106 is providing support in rendering display of video on walls of the shard 116. Further, the server 106 is providing support in shadow map and reflection map for rendering scene inside the shard 116. The client device 110 is configured to render inside the shard 116, and the server 106 is configured to render outside the shard 116. Depending on the characteristics of the client device 110, the server 106 is configured to provide support in rendering complex layers, for example, shadows and reflections within the shard 116.

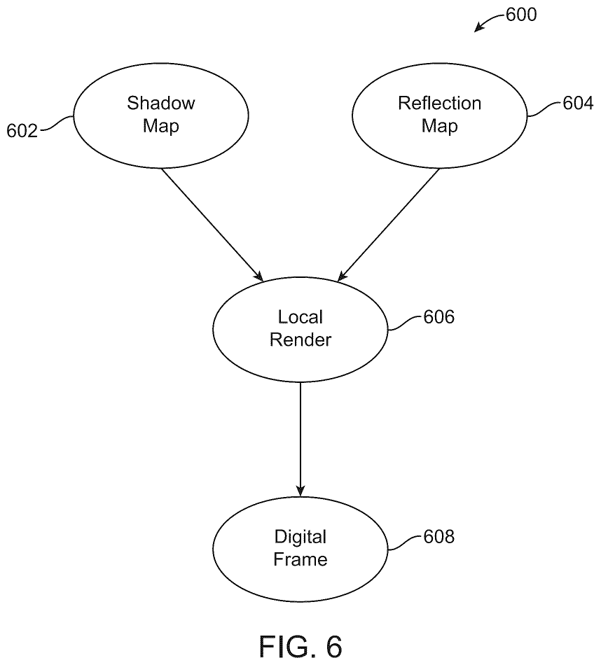

FIG. 6 is a schematic diagram 600 showing one or more layers rendered by the client device 110, according to an embodiment of the present disclosure. The shadow map 602 and the reflection map 604 are rendered by the client device 110 locally 606 and corresponding frame 608 is displayed in the shard 116. The layers are being rendered by the client device 110 and the server 106 as a negotiation between the server 106 and client device 110 to allow enhanced client device 110 performance or for network bandwidth efficiency. For example, if the shard 116 is a small cube (or box) where the player is in the center (relatively), the number of objects rendered by the client device 110 is relatively small. The simulation environment 114, for example, a game environment could be divided into shards 116. In some embodiments, a shard 116 can define a transparent box. A box houses a player and the world is rendered within the box. The world outside this ‘box’ is projected as a video on the outside walls. The server 106 is further configured to choose the dimension and location of the shard 116 and shares it with the client device 110. Further, the rendering layers of responsibility division between the client device 110 and the server 106 is negotiable. Further, information about the shard 116 is included in the stream between the server 106 to the client device 110.

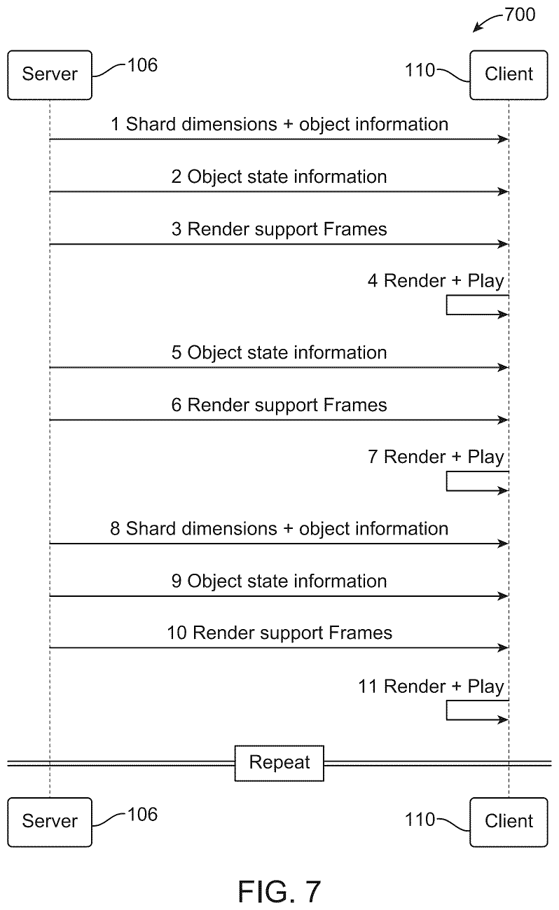

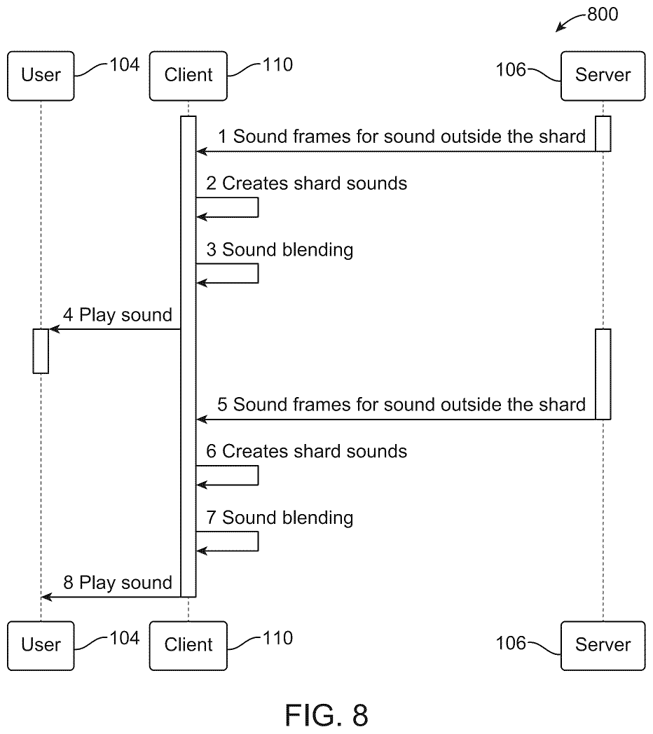

FIG. 7 exemplarily illustrates a process 700 of dynamically changing the dimension of shard 116, according to an embodiment of the present disclosure. The dimensions and location of the shard 116 are dynamic and depend on capacity of the server 106, bandwidth to the client device 110, and capabilities of the client device 110. FIG. 8 exemplarily illustrates a process 800 for dynamic control and sound rendering between the client device 110 and server 106, according to an embodiment of the present disclosure. The shard 116 further includes a sound space or a sound volume. The sound space is controlled by the server 106. The sound space is partially controlled by the client device 110 and the server 106.

The client device 110 is responsible for rendering sound within the shard 116. The server 106 is responsible for rendering sound outside the shard 116. The server 106 enables the use of deep fake sounds on the client device 110 by modifying the server-streamed sounds. The system is further configured to compute optical reflections within the shard 116. The client device 110 and the server 106 also negotiate sound shard. The server 106 will provide sounds outside the shard 116 modulated by distance from the players or the user 104. The sound provided by the server 106 is 3D structured and reflected onto the sound shard cube walls. The sound shard may differ from the shards 116 in dimension and structure. Beyond audio or sound-scape, the system is configured to compute optical reflections and other physics simulations within the shard 116. The physics scape or shard can be different from the 3D shard 116 or the sound shard in volume or the exact positioning, but may have the same overall concepts. A generalization of this would be that any phenomenon or the portion enclosed within the shard 116 can be computed once for one or more, any of, a subset of, or all observers and actors also enclosed within the same shard 114 (intro-shard) and related intra-shards.

The present disclosure further describes a method for managing a multi-user environment 102, according to another embodiment of the present disclosure. At one step, one or more client devices 110, one or more servers 106, and one or more databases 112 in communication with the server 106 via the network 108 are provided. Each client device 110 is associated with a user 104. At least one server 106 is in communication with each client device 110 via the network 108. The database 112 comprises information related to the plurality of simulation environments 114.

At another step, at least one shard 116 for a client device is created at the server 106. A shard 116 can encapsulate one or more volumetric spaces (e.g., as a volumetric space in the simulation or as a volumetric part of the simulation environment) and forms at least a portion of the simulation environment 114. At yet another step, the system is configured to dynamically vary the physical and logical attributes of the shard 116 including the location of the shard 116 at the simulation environment 114 and at least one characteristic of the shard 116 by at least one of the client device 110 or server 106. The characteristics of the shard 116 include dimension, shape, location, content, rendering, and/or control responsibilities. In some embodiments, the shard 116 is a dynamic shard. In some embodiments, the shard 116 is a static shard and uses over sharding. In the concept of over sharding, the system could have many static shards 116 that overlap. The static and overlapping shards 116 are defined prior to the simulation execution. The dynamic choice of which plurality of shards 116 is currently active for a specific client is done using the same criteria as for the choice of dynamic sharding described elsewhere herein. Further, the shard 116 is a physics simulation and physical attributes-based shard. The characteristics of the shard 116 are negotiable between the client device 110 and the server 106 and the characteristic of the shard 116 is varied based on one or more performance factors of at least one of client device 110 and server 106. In some embodiments, the physical attributes and/or the logical attributes may be dynamically varied based at least in part on one or more performance factors of the client device 110 and/or the server 106.

The volumetric space of the shard 116 is an enclosed volume formed by a plurality of edges. A shard 116 can comprise an acoustic shard. The acoustic shard comprises a shape and dimension different from the shard 116 having the enclosed volume. The characteristics of the acoustic shard are negotiable between the client device 110 and server 106.

At yet another step, the client device 110 and the server 106 are configured to negotiate and render at the simulation environment 114. At yet another step, the client device 110 is configured to render within the shard 116, and to render sound within the acoustic shard. At yet another step, the server 106 is configured to render at a portion proximal to a border of the shard 116 and at a portion outside the shard 116. At yet another step, the server 106 is further configured to render sound at a portion proximal to a border of the acoustic shard and at a portion outside the acoustic shard. At yet another step, the server 106 is configured to communicate to the client device 110 an information related to one or more objects to be rendered by the client device 110.

Advantageously, the present disclosure renders the environment within the shard 116 and projects the environment outside the shard 116 as video on the walls of the shard 116, thereby reducing the amount of rendering required. Further, rendering the entire simulation environment 114 is not required. The system enables the client device 110 to render at the volume of the shard 116, and the characteristics of the shard 116 depend upon the performance factors of the client device 110. Thus, the system is not limited by the number of users 104. Further, the effectiveness of the system increases with increase in the number of client devices 110, or users 104. Further, the proposed solutions also solve problems for VR/AR. There are limited and different capabilities between different VR devices, however players will want to play in the same field. An example of differences between VR devices would be differences in resolution. In another scenario, one player's shard size versus another player's shard size may be modified or scaled differently based on device 110 capability and/or current simulation states or requirements. For example, a client device with lesser capabilities (or a network with performance below a predetermined threshold) may cause a server providing content to reduce shard size regardless of the simulation states or requirements. Reducing shard size may enable the network to stream content at a reduced bandwidth and/or using reduced processing than the simulation state or requirements indicate.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Another note on the system. The distinction between client and server is fluid, thus a client can become a server to multiple other client and it depends on performance capabilities and regions.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for managing a multi-user environment, comprising:
at least one server in communication with one or more databases and a client device through a network, wherein the at least one server is configured to:
receive information corresponding to a plurality of simulation environments from the one or more databases,
generate at least one shard forming one or more volumetric spaces of at least a portion of a simulation environment of the plurality of simulation environments,
transmit the at least one shard to the client device,
dynamically vary one or both of a physical attribute or a logical attribute of the at least one shard, and
transmit the dynamically varied at least one shard to the client device.

2. The system of claim 1, wherein the physical attribute is a location of the at least one shard.

3. The system of claim 1, wherein the logical attribute is at least one characteristic of the at least one shard.

4. The system of claim 3, wherein the at least one characteristic of the at least one shard is one or more of: a dimension, a shape, a location, a content, a rendering, or a control responsibility.

5. The system of claim 1, wherein the at least one shard is a dynamic shard.

6. The system of claim 1, wherein the at least one shard is a static shard.

7. The system of claim 1, wherein the at least one shard is at least one of an acoustic shard, a volumetric shard, a physical simulation shard, or any combination thereof.

8. The system of claim 1, wherein the at least one shard is a physics simulation and a physical attributes-based shard.

9. The system of claim 3, wherein the at least one server is further configured to negotiate the at least one characteristic of the at least one shard with the client device.

10. The system of claim 3, wherein the at least one server is further configured to vary the at least one characteristic of the at least one shard based on one or more performance factors of at least one of the client device communicatively coupled to the at least one server.

11. The system of claim 1, wherein the at least one shard comprises a volumetric space that defines an enclosed volume formed by a plurality of edges.

12. The system of claim 1, wherein:
the at least one server is further configured to generate a second shard,
the second shard comprises an acoustic shard,
the acoustic shard comprises a shape and dimension different from the at least one shard, and
at least one characteristic of the acoustic shard is negotiable between the client device and the at least one server.

13. The system of claim 1, wherein the at least one server is a plurality of servers configured to negotiate and render content at the simulation environment of the plurality of simulation environments.

14. The system of claim 1, wherein the at least one server is configured to cause the client device to render content:
within the at least one shard; and
outside the at least one shard.

15. The system of claim 1, wherein the at least one server is configured to cause the client device to render content:
within the at least one shard;
at a portion proximal to a border of the at least one shard; and
at a second portion outside the shard.

16. The system of claim 1, wherein the at least one server is configured to: stream the simulation environment outside of the at least one shard as video at one or more walls of the at least one shard.

17. The system of claim 12, wherein the at least one server is configured to: cause the client device to render sound within the acoustic shard, and render the sound at a portion proximal to a border of the at least one shard and at a second portion outside the at least one shard.

18. The system of claim 2, wherein the at least one server is further configured to:
determine the location of the at least one shard, and
transmit the location to the client device.

19. The system of claim 1, wherein the at least one server is further configured to: transmit, to the client device, an information corresponding to one or more objects to be rendered by the client device.

20. The system of claim 19, wherein the information related to the at least one shard is included in a stream between the client device and the at least one server.

21. The system of claim 1, further comprising the client device and the one or more databases.

22. A method for managing a multi-user environment, the method performed by at least one server and comprising:
receiving information corresponding to a plurality of simulation environments from one or more databases;
generating at least one shard forming one or more volumetric spaces of at least a portion of a simulation environment of the plurality of simulation environments;
transmitting the at least one shard to a client device;
dynamically varying one or both of a physical attribute or a logical attribute of the at least one shard; and
transmitting the dynamically varied at least one shard to the client device.

23. The method of claim 22, wherein the physical attribute is a location of the at least one shard and wherein the logical attribute is at least one characteristic of the at least one shard.

24. The method of claim 23, wherein the varying of one or both of the physical attribute or the logical attribute of the at least one shard is based at least in part on one or more performance factors of the client device or the at least one server.

25. The method of claim 23, wherein the at least one characteristic of the at least one shard is one or more of: a dimension, a shape, a location, a content, a rendering, or a control responsibility.

26. The method of claim 22, wherein the at least one shard is a dynamic shard.

27. The method of claim 22, wherein the at least one shard is a static shard.

28. The method of claim 27, wherein the at least one shard is at least one of: an acoustic shard, a volumetric shard, a physical simulation shard, or any combination thereof.

29. The method of claim 27, wherein the at least one shard is a physics simulation and a physical attributes-based shard.

30. The method of claim 23, wherein the at least one server is a plurality of servers and the method further comprises: negotiating the at least one characteristic of the at least one shard between the client device and the plurality of servers.

31. The method of claim 24, further comprising varying the at least one characteristic of the at least one shard based on one or more performance factors of at least one of the client device or the at least one server.

32. The method of claim 22, wherein the one or more volumetric spaces of the at least one shard is an enclosed volume formed by a plurality of edges.

33. The method of claim 22, further comprising generate a second shard, wherein:
the second shard comprises an acoustic shard,
the acoustic shard comprises a shape and dimension different from the at least one shard, and
at least one characteristic of the acoustic shard is negotiable between the client device and the at least one server.

34. The method of claim 28, further comprising one or more of:
negotiating and rendering at the simulation environment by the one or more servers;
causing the negotiating and rendering at the simulation environment by the client device;
causing the rendering within the at least one shard and within the acoustic shard by the client device;
rendering outside the at least one shard, and at a portion proximal to a border of the at least one shard and at a portion outside the at least one shard;
rendering outside an acoustic volume-based shard, and at a portion proximal to a border of the at least one shard and at a portion outside the at least one shard; and
transmitting to the client device an information corresponding to one or more objects to be rendered by the client device.
